(19) United States
(12) Patent Application Publication
(10) Pub. No.: US 2016/0182726 A1
(43) Pub. Date: Jun. 23, 2016

(54) AUTOMATIC ALLOCATION OF REMOTE BRIDGES AND CONNECTION TO HOST BRIDGE

(71) Applicant: Alcatel-Lucent USA Inc., Murray Hill, NJ (US)

(72) Inventors: Alan E. Frey, Naperville, IL (US); Prashant S. Parikh, Naperville, IL (US)

(21) Appl. No.: 14/579,334

(22) Filed: Dec. 22, 2014

(51) Int. Cl. H04M 3/56

(52) U.S. Cl. CPC H04M 3/56

(57) ABSTRACT

A first bridge in a first location is allocated in response to receiving an indication of an access number called by a first conferee in the first location to join a conference call hosted by a second bridge in a second location. A first call session is established between the first conferee and the first bridge. The first bridge and the second bridge are connected so that the first conferee is joined to the conference call hosted by the second bridge.

### BACKGROUND

1. Field of the Disclosure

The present disclosure relates generally to communication systems and, more particularly, to conference calls in communication systems.

2. Description of the Related Art

Conference calls are widely used to facilitate communication between people at different locations. Participants in the conference call place a call from their local phone to a host bridge that interconnects calls from all the participants so that they can hear each other and speak to each other. The host bridge may be identified using an access number (e.g., a toll-free number such as 1-800-555-1212) that identifies the provider of the conference call service and a host number (e.g., 9994567) that identifies the host bridge used for the conference call. Participants may not incur any costs related to placing the call to the host bridge if the call is a local call or a call to a toll-free number, but the access charges for international calls to a host bridge in a different country can be quite significant, particularly in cases when the conference call lasts for an hour or more and includes several participants in multiple countries. Significant bandwidth may also be consumed by calls to the host bridge since each call session (or “leg”) requires a bandwidth that is determined by the type of codec used for information transmitted over the leg and the type of media (e.g., audio or video) transmitted over the leg. Bandwidth limitations are an important consideration in locations where bandwidth availability is low or the cost of bandwidth is high.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided for automatically allocating remote bridges for conference calls and connecting the remote bridges to a host bridge. The method includes allocating a first bridge in a first location in response to receiving an indication of an access number called by a first conferee in the first location to join a conference call hosted by a second bridge in a second location. The method also includes establishing a first call session between the first conferee and the first bridge. The method further includes connecting the first bridge and the second bridge so that the first conferee is joined to the conference call hosted by the second bridge.

In some embodiments, an apparatus is provided that automatically allocates remote bridges for conference calls and connects the remote bridge to a host bridge. The apparatus includes a processor to allocate a first bridge in a first location in response to receiving an indication of an access number called by a first conferee in the first location to join a conference call hosted by a second bridge in a second location. The apparatus also includes a transceiver to transmit signals inviting the first conferee to establish a first call session with the first bridge and inviting the first bridge to connect to the second bridge so that the first conferee is joined to the conference call hosted by the second bridge.

In some embodiments, a non-transitory computer readable medium is provided that includes instructions that when executed automatically allocate remote bridges for conference calls and connect the remote bridges to a host bridge. The instructions when executed manipulate a processor to allocate a first bridge in a first location in response to receiving an indication of an access number called by a first conferee in the first location to join a conference call hosted by a second bridge in a second location. The instructions when executed also manipulate the processor to establish a first call session between the first conferee and the first bridge. The instructions when executed manipulate the processor to connect the first bridge and the second bridge so that the first conferee is joined to the conference call hosted by the second bridge.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a communication system that supports conference calls including conferees from multiple locations according to some embodiments.

FIG. 2 is a flow diagram of a method of connecting a host conferee to a host bridge according to some embodiments.

FIG. 3 is a flow diagram of a method of connecting a remote conferee to a remote bridge according to some embodiments.

FIG. 4 is a flow diagram of a method of connecting a remote bridge to a host bridge according to some embodiments.

FIG. 5 is a flow diagram of a method of connecting an additional remote conferee to a remote bridge according to some embodiments.

FIG. 6 is a flow diagram of a method of connecting a host conferee to a host bridge according to some embodiments.

FIG. 7 is a flow diagram of a method of connecting a host conferee to a host bridge according to some embodiments.

FIG. 8 is a flow diagram of a method of connecting a remote bridge to a host bridge according to some embodiments

FIG. 9 is a block diagram of a communication system according to some embodiments.

### DETAILED DESCRIPTION

Access charges or bandwidth for international calls to a host bridge may be reduced by instructing participants in each country to call a local bridge hosted by a local host in the country. The local host then manually dials out from the local bridge to the host bridge and joins the local bridge to the conference call at the host bridge. Thus, the access charges and bandwidth consumed by the participants in each country are reduced to the cost and bandwidth of the single international call from the local bridge to the host bridge. However, manually connecting local bridges in different countries to a host bridge has a number of drawbacks. Participants in each country cannot use the access number/host number combination for the host bridge and instead they must use different access number/host number combinations to access the different local bridges. Furthermore, participants that access the conference via a local bridge are not transparent to the conference host and consequently the conference host does not have the ability to control legs for all the participants in the conference. For example, the conference host cannot mute or drop a leg of a participant that joined the conference via a local host bridge.

These drawbacks can be avoided while still reducing access charges or bandwidth consumed by legs of a conference call to a particular host's host bridge from conferees in a different location (such as a different country) by allocating a remote bridge in the different location in response to a conferee calling an access number for the host bridge from the different location. For example, an application server (which may be referred to as a Conference Manager Application Server or CMAS) may allocate a remote bridge in a first country in response to the conferee calling the access number associated with the first country to join a conference that is hosted in a second country. The application server may then connect the remote bridge in the first country to the host bridge in the second country. Conferees in the first country may then be automatically connected to the remote bridge rather than to the host bridge. The application server also establishes a call session between the host bridge and the remote bridge and connects the call from the conferee to the remote bridge for the conference. At this point, the conferee can hear (or see) the other conferees who have joined the conference via the host bridge or the remote bridge. Subsequent calls from other conferees in the first country to the access number for the conference hosted in the second country are automatically connected to the remote bridge in the first country. The application server may allocate a remote bridge in response to the first call to the access number for the host bridge by the first conferee at the location or the application server may allocate the remote bridge in response to the number of calls to the access number by conferees at the location exceeding a threshold number, such as five participants.

A database stores information identifying each conferee, the remote bridge or host bridge that provides access to each conferee, and the leg on the remote bridge or host bridge used for each conferee. For example, the conferee may be associated with the remote bridge or host bridge based on the country code of the access number dialed by the conferee to join the conference call. The application server may then access this information from the database to make all the conferees visible to the host so that the host can control the individual call sessions for each participant, e.g., by muting, unmuting, or dropping the call session. For example, the host may provide input that requests that the application server perform an action associated with one of the conferees. The application server may access the database to identify the conferee indicated in the request, the remote bridge or host bridge that is providing access to the conferee, and the leg used by the conferee. The application server can then perform the action indicated in the request or the application server can provide instructions that cause the action to be performed. If conferees from a third country call an access number for the host bridge, the application server can allocate a remote bridge in the third country and connect the remote bridge to the host bridge, as discussed herein. Conferees in the third country are connected to the remote bridge in the third country and the database is updated to include the information identifying the conferees in the third country, the remote bridge in the third country, and the legs of the remote bridge used for the conferees in the third country. The host bridge and the remote bridges may be allocated a publically routable number (e.g., from a pool of numbers or uniform resource identifiers (URIs) allocated to the host bridge) so that the remote bridges can be connected to the host bridge over a public network.

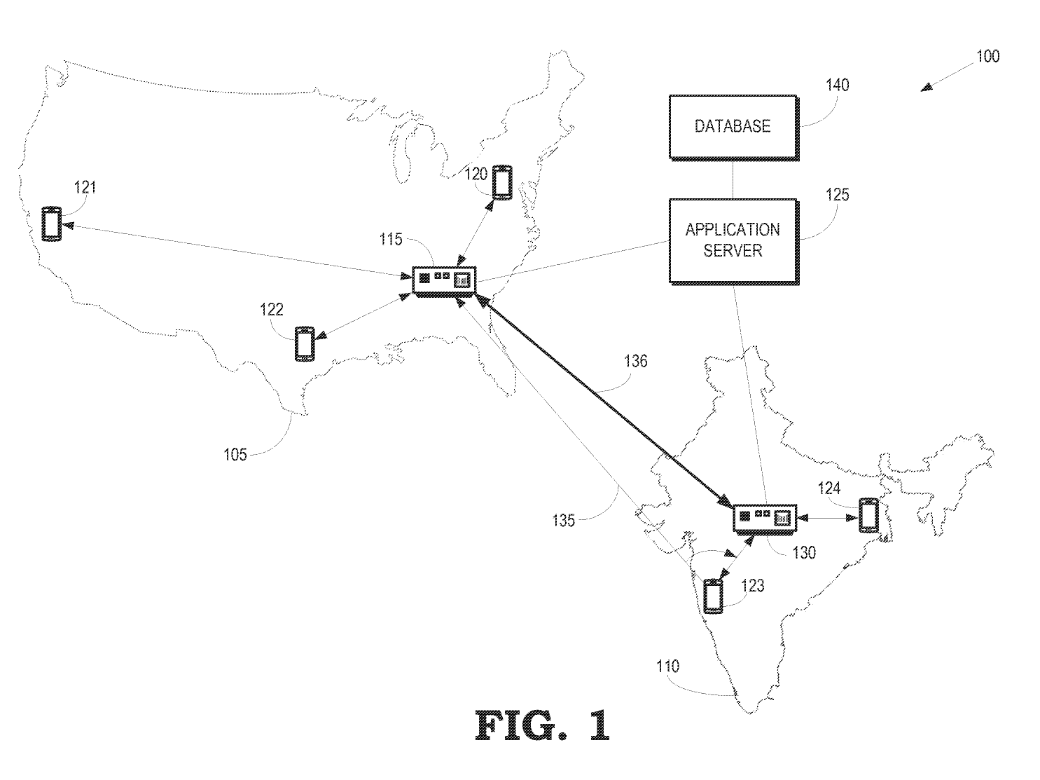

FIG. 1 is a diagram of a communication system 100 that supports conference calls including conferees from multiple locations according to some embodiments. The multiple locations shown in FIG. 1 include different countries such as the United States (indicated by the outline 105 and referred to herein as the location 105) and India (indicated by the outline 110 and referred to herein as the location 110). However, the different locations are not necessarily limited to different countries and in some embodiments the different locations may correspond to different cities, states, regions, continents, and the like. Although two locations 105, 110 are shown in FIG. 1, embodiments of the techniques described herein may be applied to conference calls hosted in one location that involve conferees in more than one other location such as conferees in two or more other countries.

A conference call is hosted by a host bridge 115 that is deployed in the location 105. Conferees 120, 121, 122, 123, 124 (referred to collectively as “the conferees 120-124”) in the locations 105, 110 may join the conference call by calling or dialing an access number for the host bridge 115 and then entering a host number (which may also be referred to as an access code or a conference number) that identifies the specific conference call. For example, the conferee 120 may be the conference host and may join the conference call by calling an access number, which may be a U.S. toll-free number such as 1-800-555-1212 for the host bridge 115 and then entering host number 9994567 to identify the conference call. The conferees 121, 122 may also join the conference call by calling the U.S. toll number 1-815-555-1212 (equivalent to toll-free for international users) for the host bridge 115 and then entering the host number 9994567 to identify the conference call. Conferees 120-124 in different locations 105, 110 may use different access numbers to call the host bridge 115 and then use the same host number to identify the conference call. For example, the conferee 123 in the location 110 may use a country-specific access number such as an access number in the India format of 0+(STD Code—3 digits)+(Telephone number—8 digits), e.g., an access number of 020-30303030 may be used to call the host bridge 115 from a location near Pune. The conferee 123 in the location 110 may then use the same host number 9994567 to identify the conference call hosted by the conferee 120.

As discussed herein, the cost and bandwidth associated with connections between the host bridge 115 and the conferees 123, 124 in the location 110 may be significant, particularly when the locations 105, 110 correspond to different countries such as the United States and India. The communication system 100 may therefore include an application server 125 that can allocate one or more remote bridges in other locations in response to conferees joining (or attempting to join) the conference call from the other locations. For example, the application server 125 may allocate a remote bridge 130 in the location 110 in response to the conferee 123 calling the access number for the host bridge 115, as indicated by the arrow 135. Allocating the remote bridge 130 may include transmitting signals to a server to instruct the server to instantiate a software bridge.

Once the remote bridge 130 has been allocated, the application server 125 may provide signals instructing the remote bridge 130 to establish a call session 136 with the host bridge 115 so that the conferee 123 may join the conference call hosted by the host bridge 115. Some embodiments of the host bridge 115 or the remote bridge 130 may be allocated public user identifiers (PUIDs) so that the host bridge 115 and the remote bridge 130 so that the call session 135 may be established over a public network.

The application server 125 may also provide signals that are used to instruct the remote bridge 130 to establish the call sessions with conferees 123, 124 in the location 110. For example, the conferee 123 may receive signals inviting the conferee 123 to establish a call connection with the remote bridge 130, e.g., the conferee 123 may receive a Session Initiation Protocol (SIP) invite message from the remote bridge 130. Additional conferees such as the conferee 124 may also be invited to establish a call connection with the remote bridge 130 in response to calling the access number of the host bridge 115. The conferee 124 may then be joined to the conference call, e.g., in response to the conferee 124 providing the host number of the conference call.

The remote bridge 130 may be instantiated in response to the number of conferees calling the host bridge 115 to join the conference call exceeding a threshold. In some embodiments, the threshold number is one (1) so that the remote bridge 130 is instantiated in response to the first conferee 123 calling to join the conference call. This approach has the advantage of reducing the number of call sessions that may need to be transferred from the host bridge 115 to the remote bridge 130, but has the corresponding drawback that the overhead of instantiating the remote bridge 130 may be wasted if only a single conferee 123 joins the conference call from the location 110. In other embodiments, the threshold number is greater than one so that the remote bridge 130 is not instantiated until more than one conferee has called to join the conference call. This approach avoids wasting the overhead of instantiating the remote bridge 130 for a single conferee 123, but may incur additional overhead associated with transferring one or more call sessions from the host bridge 115 to the remote bridge 130 after the remote bridge 130 has been instantiated. The threshold number may therefore be set to balance these trade-offs.

A database 140 stores information identifying one or more of the conferees 120-124, the host bridge 115, the remote bridge 130, the call session legs associated with the conferees 120-124, and the like. Some embodiments of the application server 125 may provide information identifying the conferees 120-124 and one of the corresponding bridges 115, 130 in response to the conferees 120-124 joining the conference call. For example, the application server 125 may provide information identifying the conferee 120 and the host bridge 115 to the database 140 in response to the conferee 120 joining the conference call. For another example, the application server 125 may provide information identifying the conferee 123 and the remote bridge 130 to the database 140 in response to the conferee 123 joining the conference call. The host bridge 115 and the remote bridge 130 may be identified by public user identifiers (PUIDs) that are allocated to the host bridge 115 and the remote bridge 130. Some embodiments of the application server 125 may also provide information to the database 140 that identifies the individual call session legs that are used to connect the conferees 120-124 to their corresponding bridges 115, 130.

The conference call is hosted by the conferee 120, who may be referred to as the host 120. Information in the database 140 may be used to make the conferees 123, 124 in the location 110 transparent to the host 120 of the conference call. The host 120 may therefore be able to control the call sessions of the conferees 123-124 individually by sending commands to the application server 125. For example, the host 120 may be able to access information identifying the conferees 123, 124, the remote bridge 130 that is being used to connect the conferees 123, 124 to the conference call, and the call session legs that are used to connect the conferees 123, 124 to the remote bridge 130. The host 120 may then use this information to individually mute, unmute, or drop call session legs for the conferees 123, 124 associated with the remote bridge 130. The host 120 may also control the call sessions of the conferees 121, 122 that are connected to the host bridge 115 using either information stored by the host bridge 115 or information stored at the database 140.

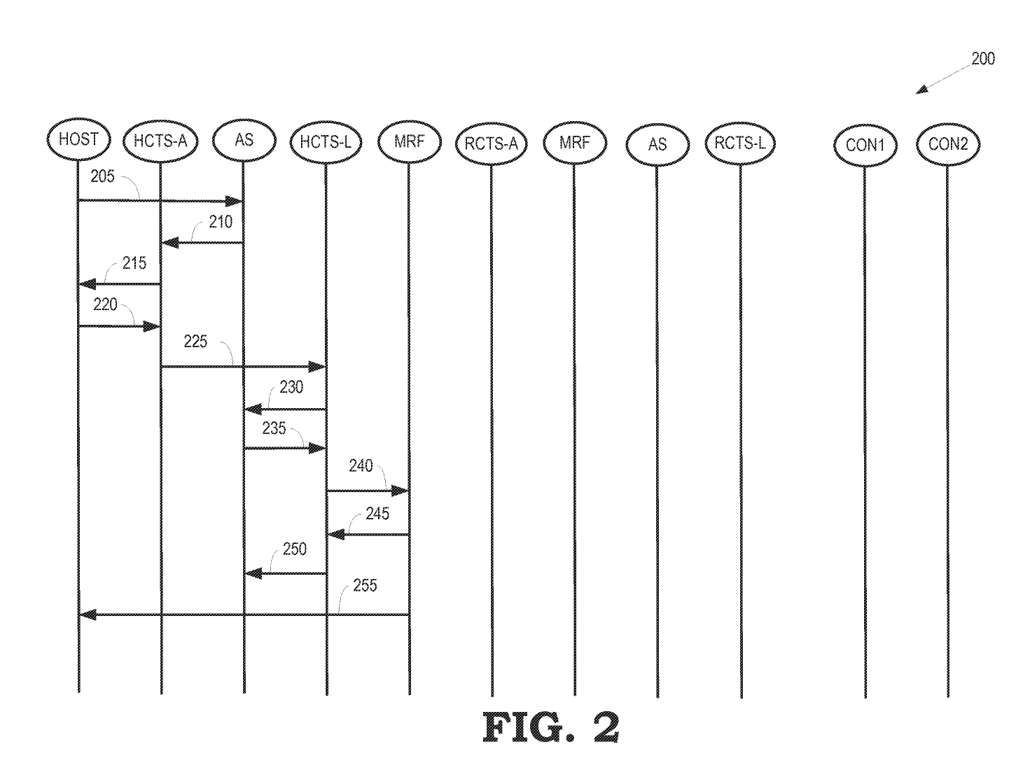

FIG. 2 is a flow diagram of a method 200 of connecting a host conferee to a host bridge according to some embodiments. The method 200 involves messages exchanged between a host conferee (HOST) such as the conferee 120 shown in FIG. 1, an application server (AS) such as the application server 125 shown in FIG. 1, a portion (HCTS-A) of a host call telephony system that is accessed using an access number, a portion (HCTS-L) of the host call telephony system that is accessed using a logical number that identifies the conference call, and a media resource function (MRF). In some embodiments, the HCTS-A and HCTS-L may be implemented in a host bridge such as the host bridge 115 shown in FIG. 1. The logical number may be allocated from a pool of logical numbers that are allocated to the host bridge. For example, the host bridge may allocate the logical number to a conference call that is identified by a host number so that calls directed to the host number are associated with the logical number of the conference call. The communication system also includes an RCTS-A associated with a remote bridge such as the remote bridge 130 shown in FIG. 1, an RCTS-L associated with the remote bridge, and remote conferees (CON1, CON2) in the remote location such as the conferees 123, 124 shown in FIG. 1. In some embodiments, the RCTS-A and RCTS-L may be implemented in a remote bridge such as the remote bridge 130 shown in FIG. 1. The entities of the communication system (such as the AS or MRF) may be implemented in a centralized manner or a distributed manner. For example, the AS may be implemented as a centralized entity in one location or may be distributed at different locations such as the locations of the host bridge and the remote bridge. Similarly, the MRF may be implemented as a centralized entity in one location or may be distributed at different locations.

In the illustrated embodiment, the communication system implements a click-to-join technique that allows the conference host to click on a link that initiates the process of joining the conference call. At 205, the conference host clicks on a link for the conference call, which causes a message to be sent to the AS requesting that a conference call be established at a host bridge and requesting that the conference host be connected to the host bridge. In the illustrated embodiment, the AS has already been configured with the host number for the conference call. The message may therefore include an access number and the host number to identify the conference call to the AS. At 210, the AS provides a message to the HCTS-A in the host bridge to instruct the host bridge to invite the conference host to the conference call. At 215, the HCTS-A in the host bridge provides an invitation (such as a SIP invite) to the conference host and the conference host acknowledges reception of the invitation at 220.

At 225, the HCTS-A provides an invitation (such as a SIP invite) to the HCTS-L, e.g., using the logical number that identifies the conference call to the HCTS-L. At 230, the HCTS-L provides a call direction notification to the AS to request confirmation that the conference call is to be configured using the host bridge. The AS performs the confirmation and provides (at 235) a response indicating that the conference call has been confirmed so that the host bridge can be allocated. The host bridge is then created (e.g., by allocating or instantiating a bridge). At 240, the HCTS-L connects the conference host to the host bridge by sending an invitation to the MRF. At 245, the MRF responds with a confirmation that the conference host has been connected to the host bridge. At 250, the HCTS-L notifies the AS that the host bridge has been created and the conference host has been connected to the host bridge. At 255, the conference host is connected to the host bridge for the conference call.

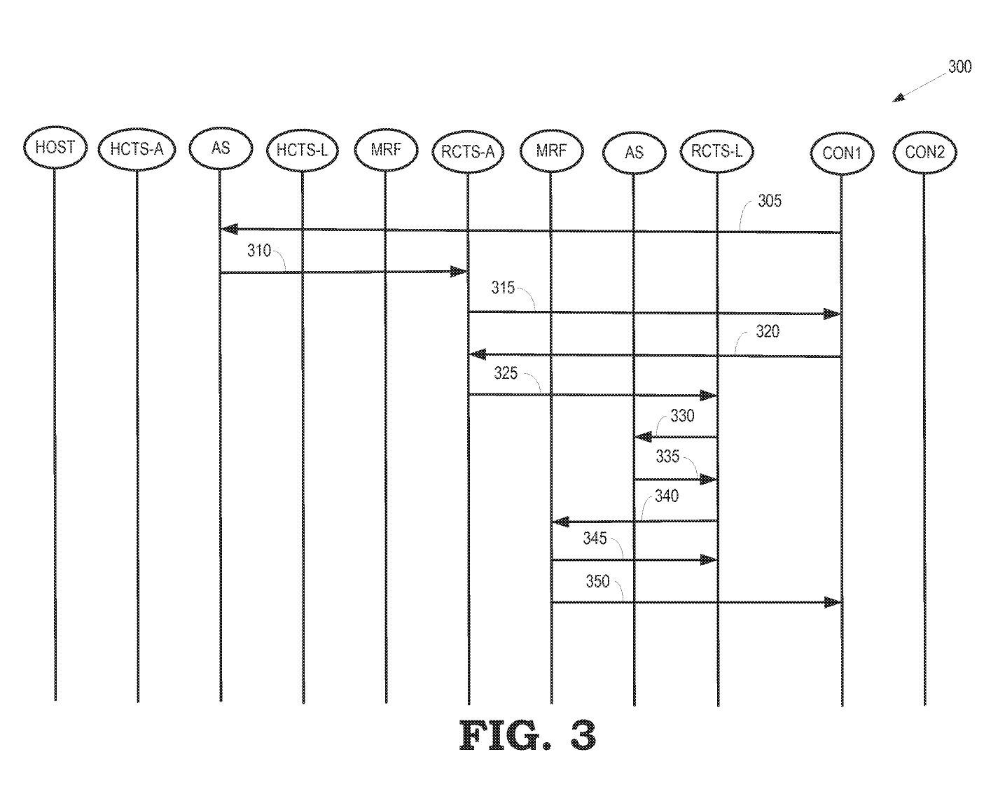

FIG. 3 is a flow diagram of a method 300 of connecting a remote conferee to a remote bridge according to some embodiments. The method 400 may be implemented in a communication system that includes elements corresponding to the previously described elements shown in FIG. 3.

In the illustrated embodiment, the communication system implements a click-to-join technique that allows the conferees to click on a link that initiates the process of joining the conference call. At 305, the first remote conferee clicks on a link to join the conference, which causes a message to be sent to the AS asking to join the conference call hosted at the host bridge, which is indicated by the access number of the host bridge in the message. For example, clicking on the link may cause the first remote conferee to call an access number for the host bridge and may provide the host number to identify the conference call to the AS. The AS then determines that the first remote conferee is calling from a remote location that is different than the location of the host bridge. For example, the AS may determine that the first remote conferee is calling from a different country using the country code included in the access number used by the first conferee. In response, the AS provides (at 310) signals or instructions to the RCTS-A to initiate allocation of a remote bridge. As discussed herein, the remote bridge may be allocated in response to the number of remote conferees exceeding a threshold number. At 315, the RCTS-A sends an invitation (e.g., a SIP invite message) to the first remote conferee to establish a call session with the remote bridge. At 320, the first remote conferee confirms receipt of the invitation by sending a confirmation message to the RCTS-A.

At 325, the RCTS-A provides an invitation (such as a SIP invite) to the RCTS-L, e.g., using the logical number that identifies the conference call to the RCTS-L. At 330, the RCTS-L provides a call direction notification to the AS to request confirmation that the conference call is to be configured using the remote bridge. The AS performs the confirmation and provides (at 335) a response indicating that the conference call has been confirmed so that the remote bridge can be allocated. The remote bridge is then created (e.g., by allocating or instantiating a bridge). At 340, the RCTS-L connects the conference host to the host bridge by sending an invitation to the MRF. At 345, the MRF responds with a confirmation that the conference host has been connected to the host bridge. At 350, the first remote conferee has established a call session and is connected to the remote bridge.

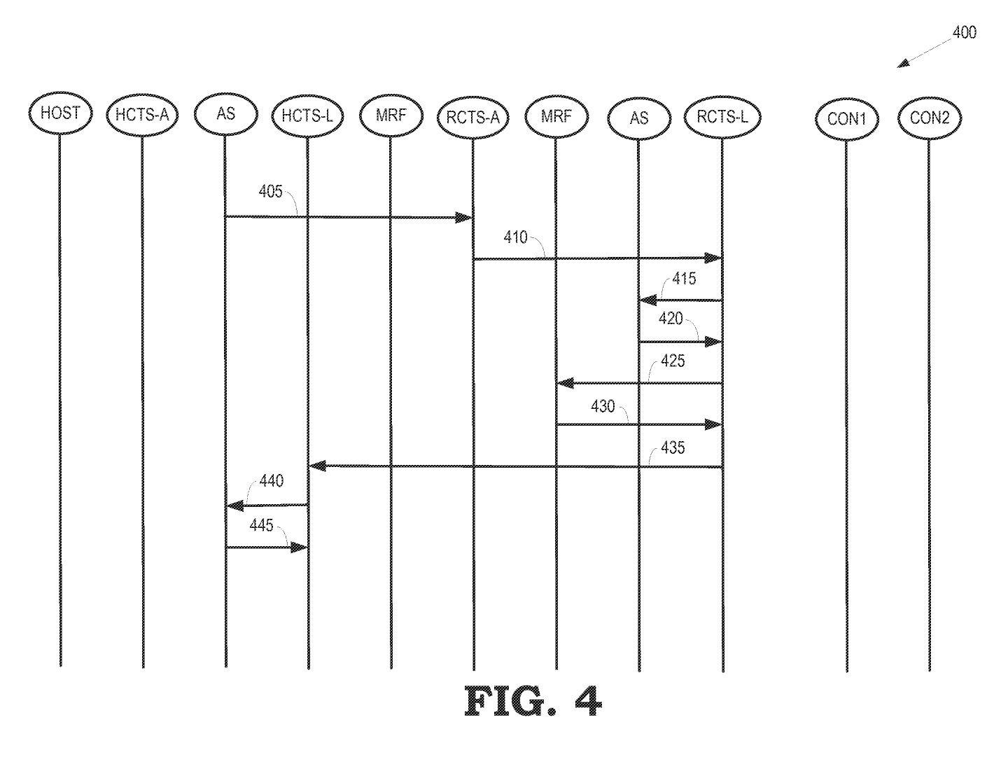

FIG. 4 is a flow diagram of a method 400 of connecting a remote bridge to a host bridge according to some embodiments. The method 400 may be implemented in a communication system that includes elements corresponding to the previously described elements shown in FIG. 2.

At 405, the AS transmits a message to the RCTS-A associated with the remote bridge. The message may be addressed to the RCTS-A using an identifier of the remote bridge such as a PUID assigned to the remote bridge. At 410, the RCTS-A sends an invitation (such as a SIP invite) to the RCTS-L to invite the remote bridge to establish a call connection with the host bridge, which may be identified using an identifier such as a PUID assigned to the host bridge. At 415, the RCTS-L provides a call direction notification to the AS to request routing information for the call connection that is to be established between the remote bridge and the host bridge. At 420, the AS provides a response to the RCTS-L including the routing information. At 425, the RCTS-L sends an invitation to the MRF to establish a call session for the call connection between the remote bridge and the host bridge. At 430, the MRF responds with a confirmation that the call session has been established.

At 435, the RCTS-L sends an invitation to the HCTS-L to join the call session and establish the call connection between the remote bridge and the host bridge. At 440, the HCTS-L sends a call direction notification to the AS to ask to join the call session. The AS may then join the HCTS-L to the call session. At 445, the AS provides a message to the HCTS-L to confirm that the host bridge has been connected to the call session to form the call connection between the remote bridge and the host bridge. At this point, the remote bridge and the host bridge are connected and the host and the first conferee are both joined to the conference call. As discussed herein, the AS may store information identifying the host, the first conferee, the remote bridge, the host bridge, a call session leg between the host and the host bridge, a call session leg between the first conferee and the remote bridge, and the like in a database such as the database 140 shown in FIG. 1.

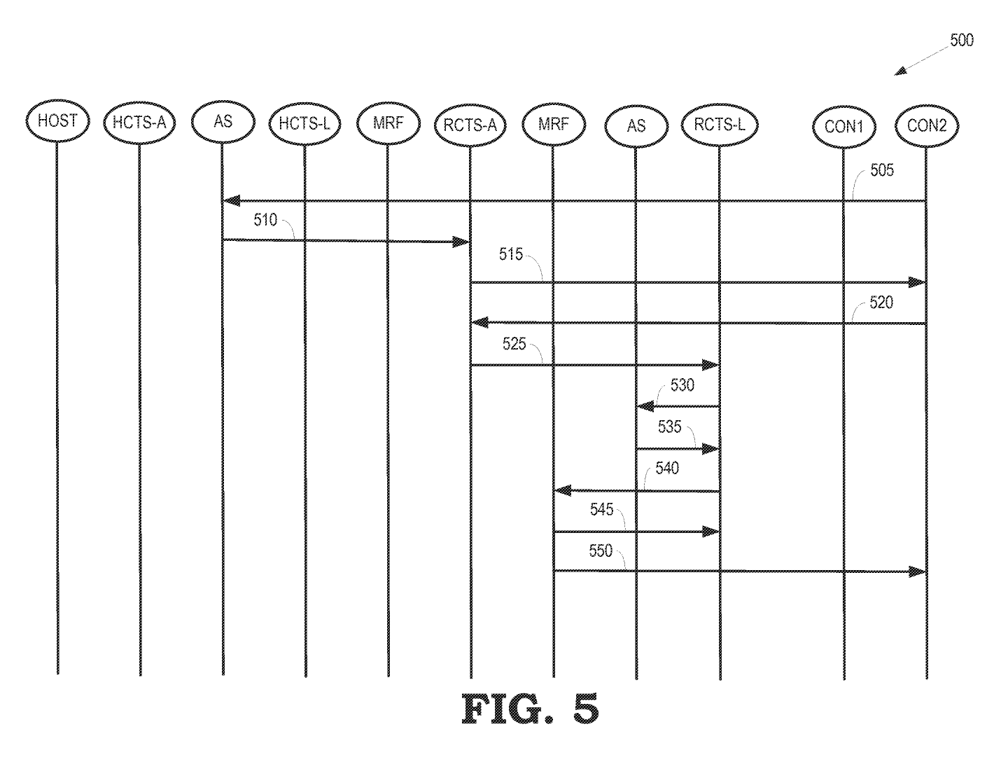

FIG. 5 is a flow diagram of a method 500 of connecting an additional remote conferee to a remote bridge according to some embodiments. The method 500 may be implemented in a communication system that includes elements corresponding to the previously described elements shown in FIG. 2.

In the illustrated embodiment, the communication system implements a click-to-join technique that allows the conference host or other conferees to click on a link that initiates the process of joining the conference call. At 505, the second remote conferee clicks on a link to join the conference call, which causes a message to be sent to the AS asking to join the conference call hosted at the host bridge, which is indicated by the access number of the host bridge in the message. For example, clicking on the link may cause the second remote conferee to call the access number for the host bridge and may provide the host number to identify the conference call to the AS. The AS then determines that the second remote conferee is calling from the same remote location as the first remote conferee. For example, the AS may determine that the second remote conferee is calling from the same country as the first remote conferee using the country code included in the access number used by the second remote conferee. In response, the AS provides (at 510) signals or instructions to instruct the RCTS-A to invite the second remote conferee to join the conference by establishing a call session leg with the remote bridge. At 515, the RCTS-A sends an invitation (e.g., a SIP invite message) to the second remote conferee to establish a call session with the remote bridge. At 520, the second remote conferee confirms receipt of the invitation by sending a confirmation message to the RCTS-A.

At 525, the RCTS-A provides an invitation (such as a SIP invite) to the RCTS-L, e.g., using the logical number that identifies the conference call to the RCTS-L. At 530, the RCTS-L provides a call direction notification to inform the AS that the second remote conferee is asking to join the remote bridge. The AS provides (at 535) a response indicating that the request from the second remote conferee has been confirmed so that the second remote conferee can establish a call session with the remote bridge. At 540, the RCTS-L sends an invitation to the MRF to connect the second remote conferee to the remote bridge so that the second remote conferee can join the conference call. At 545, the MRF responds with a confirmation. At 550, the second remote conferee has established a call session and is connected to the remote bridge. At this point, the second remote conferee is joined to the conference call hosted by the host bridge.

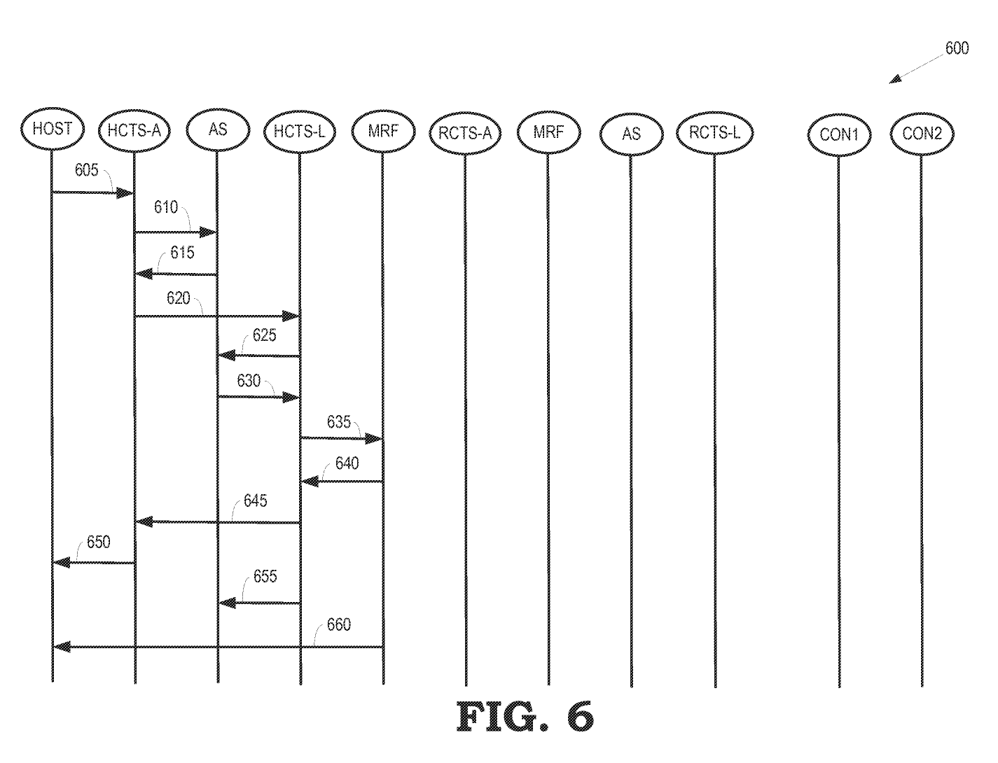

FIG. 6 is a flow diagram of a method 600 of connecting a host conferee to a host bridge according to some embodiments. The method 600 may be implemented in a communication system that includes elements corresponding to the previously described elements shown in FIG. 2. The method 600 shown in FIG. 6 differs from the method 200 shown in FIG. 2 because the host dials into the conference call via the host bridge instead of using click-to-join via the AS.

At 605, the conference host dials an access number for the conference call, which causes an invitation (such as a SIP invite) to be transmitted to the HCTS-A in the host bridge. At 610, the HCTS-A transmits a call direction notification to the AS to indicate that the conference host is joining the conference call. At 615, the AS returns a message confirming that the conference host may join the conference call as the host of the conference call, e.g., based on a host number provided by the conference host.

At 620, the HCTS-A provides an invitation (such as a SIP invite) to the HCTS-L, e.g., using the logical number that identifies the conference call to the HCTS-L. At 625, the HCTS-L provides a call direction notification to the AS to request confirmation that the conference call is to be configured using the host bridge. The AS performs the confirmation and provides (at 630) a response indicating that the conference call has been confirmed so that the host bridge can be allocated. The host bridge is then created (e.g., by allocating or instantiating a bridge). At 635, the HCTS-L connects the conference host to the host bridge by sending an invitation to the MRF. At 640, the MRF responds with a confirmation that the conference host has been connected to the host bridge. At 645, the HCTS-L responds with a confirmation to the HCTS-A. At 650, the HCTS-A responds with a confirmation to the conference host. At 655, the HCTS-L notifies the AS that the host bridge has been created and the conference host has been connected to the host bridge. At 660, the conference host is connected to the host bridge for the conference call.

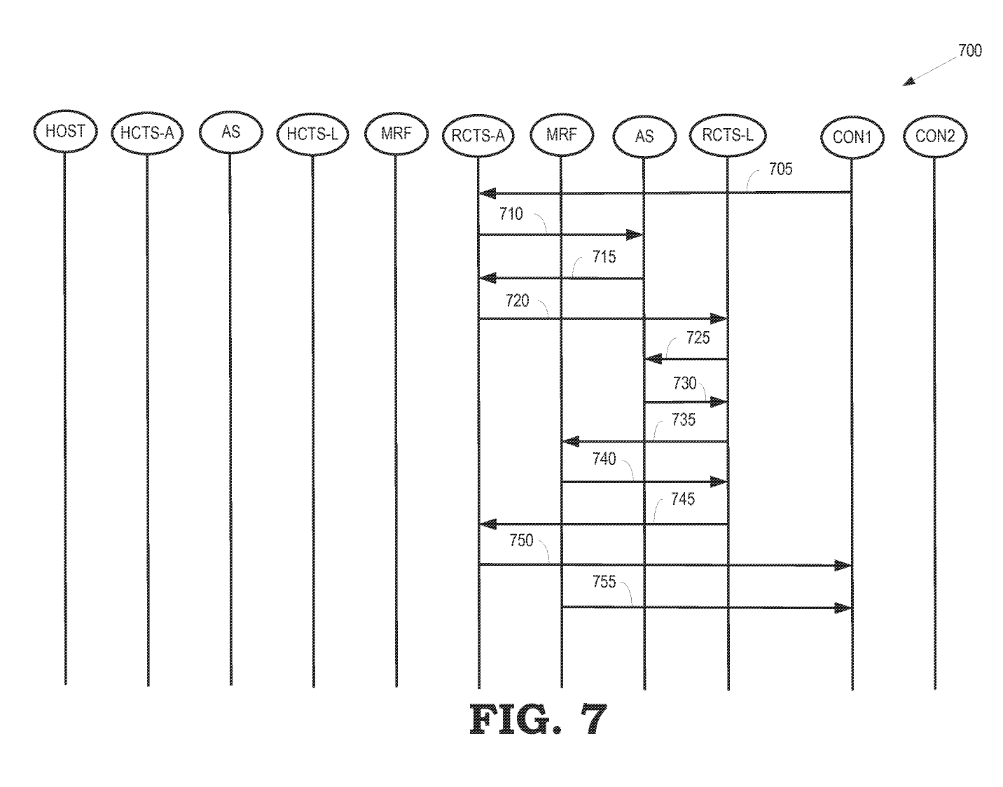

FIG. 7 is a flow diagram of a method 700 of connecting a host conferee to a host bridge according to some embodiments. The method 700 may be implemented in a communication system that includes elements corresponding to the previously described elements shown in FIG. 2. The method 700 shown in FIG. 7 differs from the method 300 shown in FIG. 3 because the conferee dials into the conference call using the access number of the host bridge instead of using click-to-join via the AS.

At 705, the first conferee dials an access number for the conference call, which causes an invitation (such as a SIP invite) to be transmitted to the RCTS-A in the remote bridge. At 610, the RCTS-A transmits a call direction notification to the AS to indicate that the first conferee is joining the conference call. The AS may then receive (e.g., by prompting the first conferee) the host number of the conference call. The AS determines that the host for the conference call is the host bridge, e.g., using information stored in a database. At 615, the AS returns a message to the RCTS-A confirming that the first conferee may join the conference call hosted by the host bridge.

At 720, the RCTS-A provides an invitation (such as a SIP invite) to the RCTS-L, e.g., using the logical number that identifies the conference call to the RCTS-L. At 725, the RCTS-L provides a call direction notification to the AS to request confirmation that the conference call is to be configured using the host bridge. The AS performs the confirmation and provides (at 730) a response indicating that the conference call has been confirmed so that the remote bridge can be allocated. The remote bridge is then created (e.g., by allocating or instantiating a bridge). At 735, the RCTS-L connects the first conferee to the remote bridge by sending an invitation to the MRF. At 740, the MRF responds with a confirmation that the conference host has been connected to the host bridge. At 745, the RCTS-L responds with a confirmation to the RCTS-A. At 750, the RCTS-A responds with a confirmation to the first conferee. At 755, the first conferee is connected to the remote bridge.

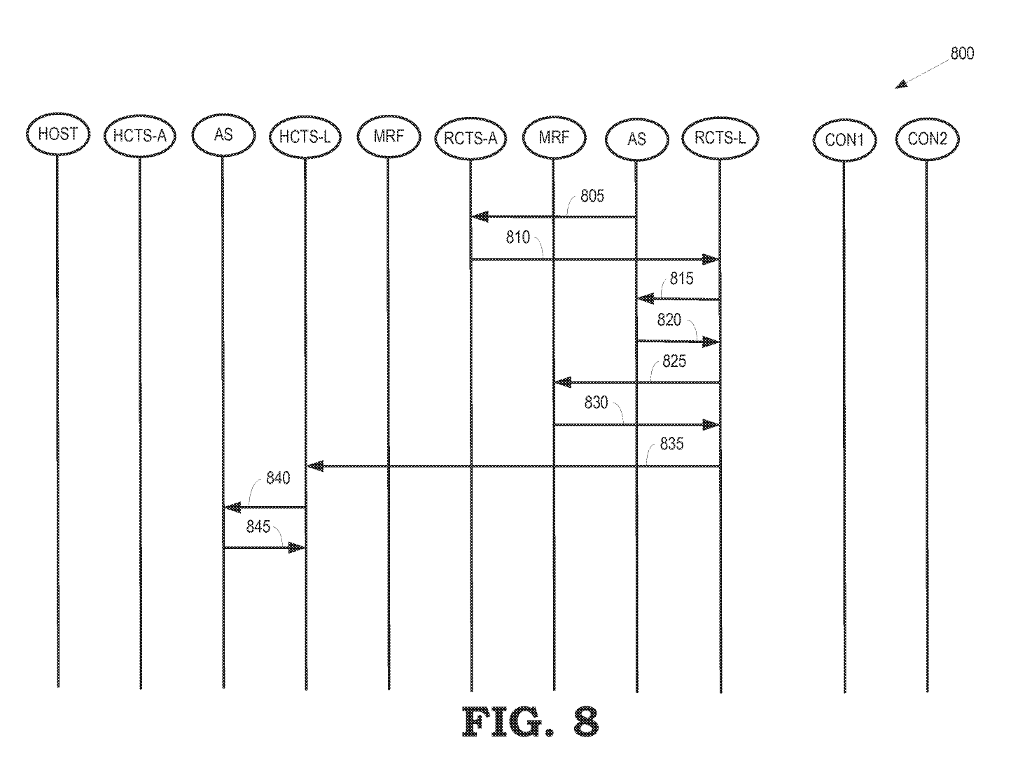

FIG. 8 is a flow diagram of a method 800 of connecting a remote bridge to a host bridge according to some embodiments. The method 800 may be implemented in a communication system that includes elements corresponding to the previously described elements shown in FIG. 2. At 805, the AS transmits a message to the RCTS-A associated with the remote bridge. The message may be addressed to the RCTS-A using an identifier of the remote bridge such as a PUID assigned to the remote bridge, which may be retrieved from a database such as the database 140 shown in FIG. 1. At 810, the RCTS-A sends an invitation (such as a SIP invite) to the RCTS-L to invite the remote bridge to establish a call connection with the host bridge, which may be identified using an identifier such as a PUID assigned to the host bridge. The PUID of the host bridge may be retrieved from the database. At 815, the RCTS-L provides a call direction notification to the AS to request routing information for the call connection that is to be established between the remote bridge and the host bridge. At 820, the AS provides a response to the RCTS-L including the routing information. At 825, the RCTS-L sends an invitation to the MRF to establish a call session for the call connection between the remote bridge and the host bridge. At 830, the MRF responds with a confirmation that the call session has been established.

At 835, the RCTS-L sends an invitation to the HCTS-L to join the call session and establish the call connection between the remote bridge and the host bridge. At 840, the HCTS-L sends a call direction notification to the AS to ask to join the call session. The AS may then join the HCTS-L to the call session. At 855, the AS provides a message to the HCTS-L to confirm that the host bridge has been connected to the call session to form the call connection between the remote bridge and the host bridge. At this point, the remote bridge and the host bridge are connected and the host and the first conferee are both joined to the conference call. As discussed herein, the AS may store information identifying the host, the first conferee, the remote bridge, the host bridge, a call session leg between the host and the host bridge, a call session leg between the first conferee and the remote bridge, and the like in a database such as the database 140 shown in FIG. 1.

Some embodiments of a communication system may implement some or all of the methods 200, 300, 400, 500, 600, 700, 800 shown in FIGS. 2-8 in various different combinations. For example, a communication system may support both click-to-join conference calls (as illustrated by the methods 200, 300, 400, 500 shown in FIGS. 2-5) and dial-in conference calls (as illustrated by the methods 600, 700, 800 shown in FIGS. 6-8). Moreover, embodiments of the communication system may perform the methods 200, 300, 400, 500, 600, 700, 800 simultaneously, concurrently, or in different orders. For example, a remote conferee may click-to-join a conference call before the host conferee has joined the conference, in which case the remote bridge may be allocated (e.g., as illustrated in the method 300 shown in FIG. 3) and connected to the host bridge (e.g., as illustrated in the method 400 shown in FIG. 4) before the host conferee is joined to the conference (e.g., as illustrated in the method 200 shown in FIG. 2). For another example, the remote bridge may be allocated (e.g., as illustrated in the method 300 shown in FIG. 3) and connected to the host bridge (e.g., as illustrated in the method 400 shown in FIG. 4) concurrently with joining the host conferee to the conference (e.g., as illustrated in the method 200 shown in FIG. 2).

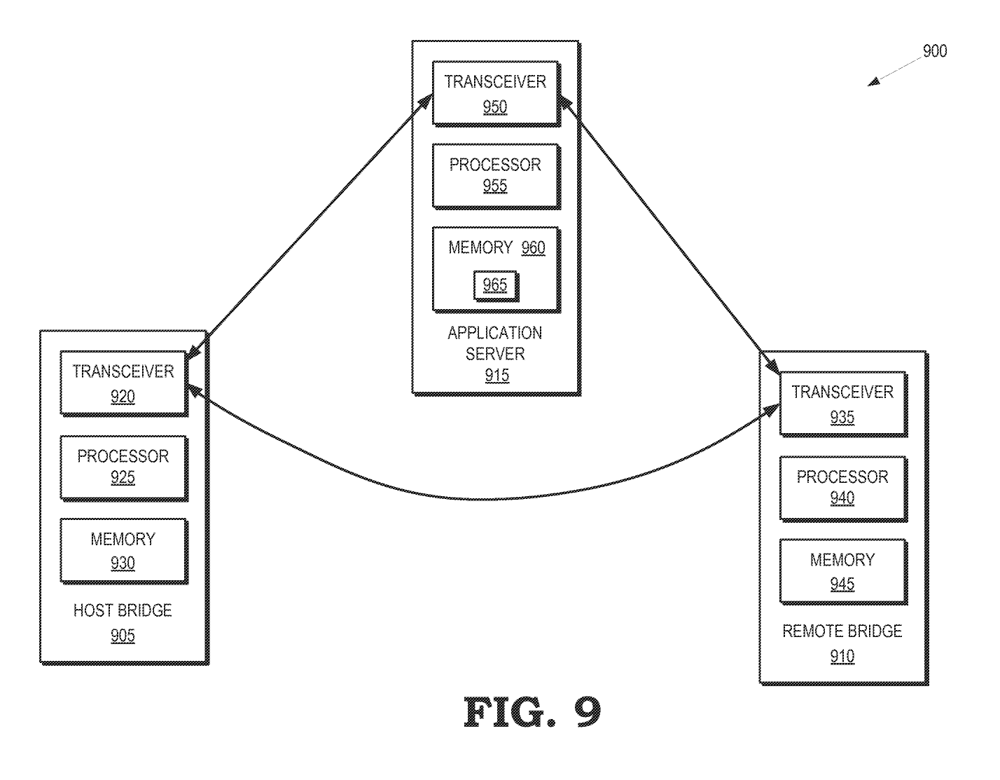

FIG. 9 is a block diagram of a communication system 900 according to some embodiments. The communication system 900 includes a host bridge 905, a remote bridge 910, and an application server 915, which, in some embodiments, may be used to implement the host bridge 115, the remote bridge 130, or the application server 125 shown in FIG. 1.

The host bridge 905 includes a transceiver 920 for transmitting and receiving signals, such as signals exchanged with the remote bridge 910 or the application server 915. Some embodiments of the transceiver 920 may also be used to exchange signals with a conference host or one or more conferees, as discussed herein. The host bridge 905 also includes a processor 925 and a memory 930. The processor 925 may be used to execute instructions stored in the memory 930 and to store information in the memory 930 such as the results of the executed instructions. Some embodiments of the transceiver 920, the processor 925, or the memory 930 may be configured to perform portions of the method 200 shown in FIG. 2, the method 300 shown in FIG. 3, the method 400 shown in FIG. 4, the method 500 shown in FIG. 5, the method 600 shown in FIG. 6, the method 700 shown in FIG. 7, or the method 800 shown in FIG. 8.

The remote bridge 910 includes a transceiver 935 for transmitting and receiving signals, such as signals exchanged with the host bridge 905 or the application server 915. Some embodiments of the transceiver 935 may also be used to exchange signals with one or more remote conferees, as discussed herein. The remote bridge 910 also includes a processor 940 and a memory 945. The processor 940 may be used to execute instructions stored in the memory 945 and to store information in the memory 945 such as the results of the executed instructions. Some embodiments of the transceiver 935, the processor 940, or the memory 945 may be configured to perform portions of the method 200 shown in FIG. 2, the method 300 shown in FIG. 3, the method 400 shown in FIG. 4, the method 500 shown in FIG. 5, the method 600 shown in FIG. 6, the method 700 shown in FIG. 7, or the method 800 shown in FIG. 8.

The application server 915 includes a transceiver 950 for transmitting and receiving signals, such as signals exchanged with the host bridge 905 or the remote bridge 910. The application server 915 also includes a processor 955 and a memory 960. The processor 955 may be used to execute instructions stored in the memory 960 and to store information in the memory 960 such as the results of the executed instructions. Some embodiments of the processor 955 and the memory 960 may be configured to perform portions of the method 200 shown in FIG. 2, the method 300 shown in FIG. 3, the method 400 shown in FIG. 4, the method 500 shown in FIG. 5, the method 600 shown in FIG. 6, the method 700 shown in FIG. 7, or the method 800 shown in FIG. 8. Some embodiments of the memory 960 include a database 965 to store information identifying the host bridge 905, the remote bridge 910, a conference host, one or more conferees, call session legs associated with the conference host or conferees, and the like, as discussed herein. The database 965 may be used to implement the database 140 shown in FIG. 1. However, in some embodiments, the memory 960 may not implement a database 965 and the database 965 may instead be implemented as a separate stand-alone entity that may be able to communicate with the host bridge 905, the remote bridge 910, or the application server 915.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
allocating a first bridge in a first location in response to receiving a request from a first conferee in the first location to join a conference call hosted by a second bridge in a second location, wherein the request includes an indication of an access number of the second bridge;
establishing a first call session between the first conferee and the first bridge; and
connecting the first bridge and the second bridge so that the first conferee is joined to the conference call hosted by the second bridge.

2. The method of claim 1, wherein allocating the first bridge comprises allocating a publicly addressable number to identify the first bridge, wherein the publicly addressable number is allocated from a pool of publicly addressable numbers allocated to the second bridge.

3. The method of claim 1, further comprising:
storing information identifying the first conferee, the first bridge, and the second bridge in a database.

4. The method of claim 3, further comprising:
establishing at least one second call session between at least one second conferee in the first location and the first bridge in response to the at least one second conferee calling the access number for the conference call hosted by the second bridge in the second location; and
storing information identifying the at least one second conferee in the database.

5. The method of claim 4, further comprising:
muting, unmuting, or dropping at least one of the first call session and the at least one second call session in response to signals received from a host of the conference call, wherein the at least one of the first call session and the at least one second call session are identified based on the information in the database identifying the first conferee, the at least one second conferee, the first bridge, and the second bridge.

6. The method of claim 1, wherein allocating the first bridge comprises allocating the first bridge in response to a number of conferees calling the access number from the first location exceeding a threshold number.

7. The method of claim 6, wherein the threshold number is one.

8. The method of claim 6, wherein the threshold number is greater than one.

9. The method of claim 8, further comprising:
transferring, from the second bridge to the first bridge, at least one call session between the second bridge and at least one third conferee that previously called the access number, wherein transferring the at least one call session occurs in response to allocating the first bridge.

10. An apparatus comprising:
a processor to allocate a first bridge in a first location in response to receiving a request from a first conferee in the first location to join a conference call hosted by a second bridge in a second location, wherein the request includes an indication of an access number of the second bridge; and
a transceiver to transmit signals inviting the first conferee to establish a first call session with the first bridge and inviting the first bridge to connect to the second bridge so that the first conferee is joined to the conference call hosted by the second bridge.

11. The apparatus of claim 10, wherein the processor is to allocate a publicly addressable number to identify the first bridge, wherein the publicly addressable number is allocated from a pool of publicly addressable numbers allocated to the second bridge.

12. The apparatus of claim 10, further comprising:
memory to store a database including information identifying the first conferee, the first bridge, and the second bridge.

13. The apparatus of claim 12, wherein the transceiver is to transmit signals inviting at least one second conferee in the first location to establish at least one second call session with the first bridge in response to the at least one second conferee calling the access number for the conference call hosted by the second bridge in the second location, and wherein the memory stores information identifying the at least one second conferee in the database.

14. The apparatus of claim 13, wherein the transceiver is to provide signals instructing the first bridge to mute, unmute, or drop at least one of the first call session and the at least one second call session in response to signals received from a host of the conference call, wherein the at least one of the first call session and the at least one second call session are identified based on the information in the database identifying the first conferee, the at least one second conferee, the first bridge, and the second bridge.

15. The apparatus of claim 10, wherein the processor is to allocate the first bridge in response to a number of conferees calling the access number from the first location exceeding a threshold number.

16. The apparatus of claim 15, wherein the threshold number is one.

17. The apparatus of claim 15, wherein the threshold number is greater than one.

18. The apparatus of claim 17, wherein the transceiver is to provide instructions to transfer, from the second bridge to the first bridge, at least one call session between the second bridge and at least one third conferee that previously called the access number, wherein the transceiver provides the instructions to transfer the at least one call session in response to allocating the first bridge.

19. A non-transitory computer readable medium embodying a set of executable instructions, the set of executable instructions to manipulate a processor to:
allocate a first bridge in a first location in response to receiving a request from a first conferee in the first location to join a conference call hosted by a second bridge in a second location, where the request includes an indication of an access number of the second bridge;
establish a first call session between the first conferee and the first bridge; and
connect the first bridge and the second bridge so that the first conferee is joined to the conference call hosted by the second bridge.

20. The non-transitory computer readable medium of claim 19, wherein the set of executable instructions are to manipulate the processor to store information identifying the first conferee, the first bridge, and the second bridge in a database.
